(19) United States
(12) Patent Application Publication
(10) Pub. No.: US 2011/0102508 A1
(43) Pub. Date: May 5, 2011

(54) Laminate substrate having bypass valve structure, inkjet print head and micro pump using the same

(75) Inventors: Changsung Sean Kim, Yongin (KR); Yongsoo Oh, Seongnam (KR); Jae Woo Joung, Suwon (KR); Young Seuck Yoo, Seoul (KR)

(73) Assignee: SAMSUNG ELECTRO-MECHANICS CO., LTD., Suwon (KR)

(21) Appl. No.: 12/654,679

(22) Filed: Dec. 29, 2009

(30) Foreign Application Priority Data
Oct. 29, 2009 (KR) 10-2009-0103709

(51) Int. Cl. B41J 2/14; F04B 17/03; F16K 15/00

(52) U.S. Cl. 347/44; 417/410.1; 137/511

(57) ABSTRACT

There is provided a laminate substrate having a bypass valve structure. The bypass valve structure formed in the laminate substrate includes a sloped path connecting a first straight path with a second straight path, and a bypass path connected with at least one of the first and second straight paths and configured as a curved path.

### CROSS-REFERENCE TO RELATED APPLICATIONS

This application claims the priority of Korean Patent Application No. 10-2009-0103709 filed on Oct. 29, 2009, in the Korean Intellectual Property Office, the disclosure of which is incorporated herein by reference.

### BACKGROUND OF THE INVENTION

1. Field of the Invention

The present invention relates to a laminate substrate having a bypass valve structure, and an inkjet print head and a micro pump using the same, and more particularly, to a laminate substrate having a bypass valve structure allowing for a considerable reduction in a reverse flow of fluid after the fluid is ejected from a pressure chamber, and an inkjet print head and a micro pump using the laminate substrate having the bypass valve structure.

2. Description of the Related Art

In general, an inkjet print head converts electrical signals into physical impulses so that ink droplets are ejected through a small nozzle. An inkjet print head may be divided into two types according to actuator driving methods, a piezoelectric-type inkjet print head using a driving force caused by the transformation of piezoelectric materials and a bubble jet-type inkjet print head allowing ink to be ejected by bubbles generated in ink using heating elements.

In recent years, a piezoelectric inkjet head has been used in industrial inkjet printers. For example, it is used to directly form a circuit pattern by spraying ink prepared by melting metals such as gold or silver onto a printed circuit board (PCB). A piezoelectric inkjet head is also used for creating industrial graphics, or for the manufacturing of a liquid crystal display (LCD), an organic light emitting diode (OLED), and a solar cell.

Inside an inkjet print head of an industrial inkjet printer, there are provided an inlet through which ink is drawn from a cartridge, a reservoir storing the ink being drawn in, a pressure chamber transferring the driving force of an actuator so as to move the ink stored in the reservoir toward a nozzle, and a restrictor forming a flow path from the reservoir to the pressure chamber and preventing the ink from flowing backwards after being ejected.

Those structures of the inkjet print head are made by forming holes or grooves in silicon or glass substrates using a micro electro mechanical systems (MEMS) process, and then stacking the substrates.

Since a conventional restrictor has a horizontal-type or perpendicular-type rectangular cross-sectional channel structure, there has been no difference in functions before and after ink ejection.

Accordingly, there is a need for research regarding the shape of a restrictor in order to prevent ink from flowing backwards after being ejected.

Also, there is a need for research in order to expand the applications of a laminate substrate having a bypass valve structure allowing for an uninterrupted flow of fluid in a forward direction and an interrupted flow of fluid in a reversed direction.

### SUMMARY OF THE INVENTION

An aspect of the present invention provides a laminate substrate having a bypass valve structure allowing for an uninterrupted flow of fluid in a forward direction and an interrupted flow of fluid in a reversed direction.

An aspect of the present invention also provides an inkjet print head including a restrictor having the bypass valve structure.

An aspect of the present invention also provides a micro pump having the bypass valve structure.

According to an aspect of the present invention, there is provided a laminate substrate having a bypass valve structure. The bypass valve structure formed in the laminate substrate includes a sloped path connecting a first straight path with a second straight path, and a bypass path connected with at least one of the first and second straight paths and configured as a curved path.

The first and second straight paths may be consecutively connected by the sloped path, and at least one of the first and second straight paths may be connected with the bypass path.

The first straight path and the sloped path may be formed in different substrates.

The first and second straight paths may be formed in a first substrate, and the sloped path and the bypass path connected with at least one of the first and second straight paths may be formed in a second substrate.

According to another aspect of the present invention, there is provided an inkjet print head including: a reservoir storing ink drawn through an inlet; a pressure chamber storing the ink supplied by the reservoir before being ejected through a nozzle and allowing the stored ink to be ejected by a driving force of a piezoelectric element; and a restrictor connecting the reservoir with the pressure chamber. The restrictor includes a sloped path connecting a first straight path with a second straight path, and a bypass path connected with at least one of the first and second straight paths and configured as a curved path.

The first and second straight paths may be consecutively connected by the sloped path, and at least one of the first and second straight paths may be connected with the bypass path.

The first straight path and the sloped path may be formed in different substrates.

The first and second straight paths may be formed in a first substrate, and the sloped path and the bypass path connected with at least one of the first and second straight paths may be formed in a second substrate.

According to another aspect of the present invention, there is provided a micro pump including a pressure chamber including a piezoelectric element allowing for a pumping of fluid, and an inlet and an outlet through which the fluid is respectively drawn into and ejected from the pressure chamber. At least one of the inlet and the outlet includes a flow path structure formed in a laminate substrate. The flow path structure includes a sloped path connecting a first straight path with a second straight path, and a bypass path connected with at least one of the first and second straight paths and configured as a curved path.

The first and second straight paths may be consecutively connected by the sloped path, and at least one of the first and second straight paths may be connected with the bypass path.

The first straight path and the sloped path may be formed in different substrates.

The first and second straight paths may be formed in a first substrate, and the sloped path and the bypass path connected with at least one of the first and second straight paths may be formed in a second substrate.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view schematically illustrating a laminate substrate having a bypass valve structure according to an exemplary embodiment of the present invention;

FIG. 2 schematically illustrates a flow of fluid in a forward direction in the bypass valve structure of FIG. 1;

FIG. 3 schematically illustrates a flow of fluid in a reversed direction in the bypass valve structure of FIG. 1;

FIG. 4 is an exploded perspective view schematically illustrating a laminate substrate having a bypass valve structure according to another exemplary embodiment of the present invention;

FIG. 5 schematically illustrates a flow of fluid in a forward direction in the bypass valve structure of FIG. 4;

FIG. 6 schematically illustrates a flow of fluid in a reversed direction in the bypass valve structure of FIG. 4;

FIG. 7 schematically illustrates a restrictor having the bypass valve structure of FIG. 1 in an inkjet print head according to an exemplary embodiment of the present invention;

FIG. 8 schematically illustrates a restrictor having the bypass valve structure of FIG. 4 in an inkjet print head according to another exemplary embodiment of the present invention;

FIG. 9 schematically illustrates an inlet and an outlet having the bypass valve structure of FIG. 4 in a micro pump according to an exemplary embodiment of the present invention; and

FIG. 10 schematically illustrates a consecutive arrangement of bypass valve structures according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same reference numerals will be used to refer to the same or like parts.

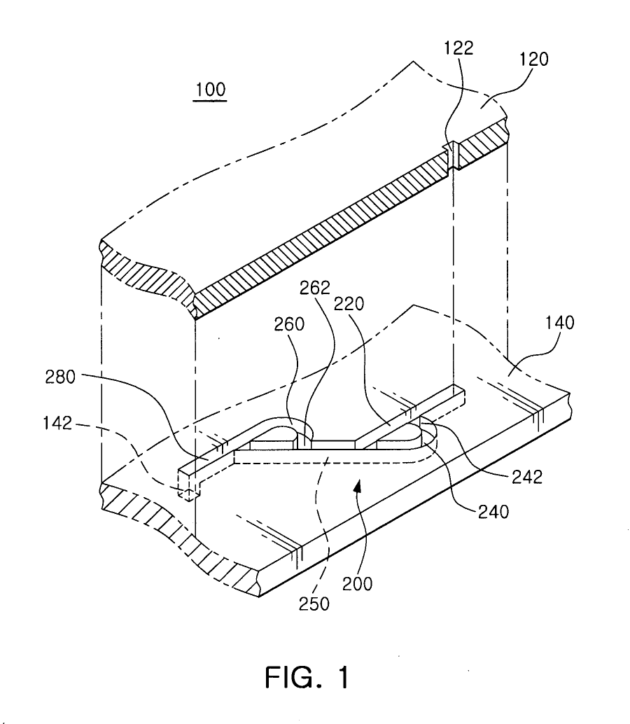

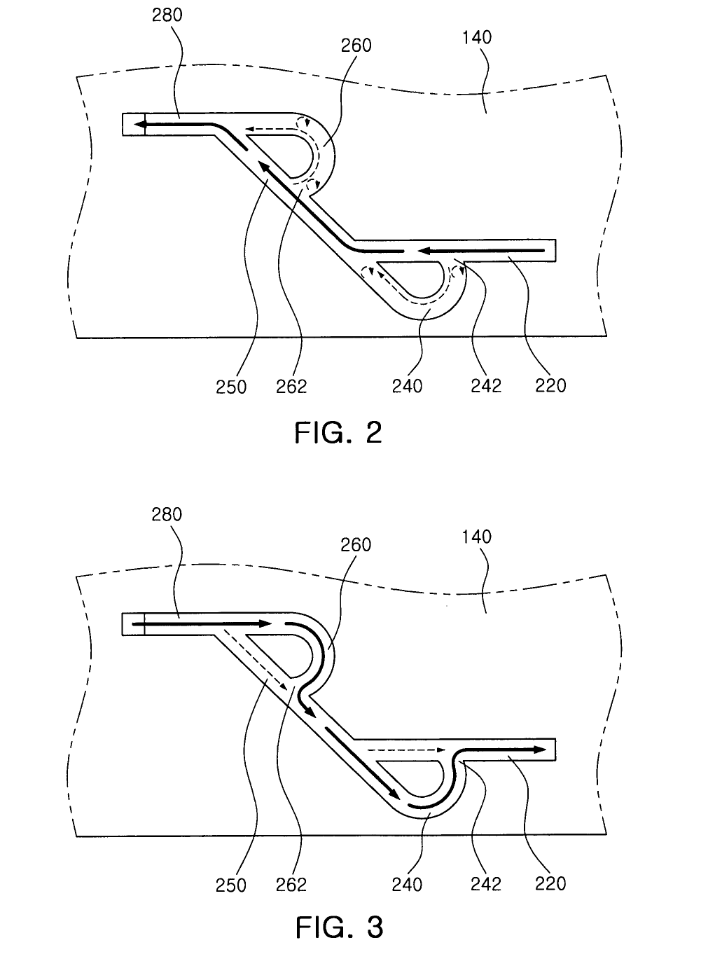

FIG. 1 is an exploded perspective view schematically illustrating a laminate substrate having a bypass valve structure according to an exemplary embodiment of the present invention. FIG. 2 schematically illustrates a flow of fluid in a forward direction in the bypass valve structure of FIG. 1. FIG. 3 schematically illustrates a flow of fluid in a reversed direction in the bypass valve structure of FIG. 1.

Referring to FIGS. 1 through 3, a laminate substrate 100 having a bypass valve structure according to an exemplary embodiment of the invention is a laminate structure of an upper substrate 120 and a lower substrate 140. The lower substrate 140 may have a bypass valve structure 200 formed therein.

A flow path of the bypass valve structure may be formed to be recessed into the upper substrate 120 or into both the upper and lower substrates 120 and 140. The flow path may be formed by stacking the upper and lower substrates 120 and 140.

The present embodiment provides a two-layered structure of the upper and lower substrates. However, the height of the flow path may increase by disposing a plurality of intermediate substrates between the upper and lower substrates.

The bypass valve structure 200 may include a first straight path 220, a second straight path 280, a sloped path 250, and at least one of bypass paths 240 and 260.

The first straight path 220 may be connected to an inlet 122 through which a fluid is drawn, and the second straight path 280 may be connected to an outlet 142 through which the fluid is ejected. The first and second straight paths 220 and 280 may be parallel to each other. In some cases, however, the first and second straight paths 220 and 280 may be disposed to have a predetermined angle therebetween.

The sloped path 250 may connect the first straight path 220 with the second straight path 280 and may be slantly formed between the parallel-formed first and second straight paths 220 and 280.

The bypass path may be connected with at least one of the first and second straight paths 220 and 280. The bypass path may be configured as a curved path.

The bypass path connecting the first straight path 220 with the sloped path 250 is defined as a first bypass path 240 and the bypass path connecting the second straight path 220 with the sloped path 250 is defined as a second bypass path 260.

Reviewing the courses of fluid transfer with reference to FIGS. 2 and 3, the fluid drawn through the inlet 122 is firstly transferred in a forward direction according to the shortest course, i.e. , through the first straight path 220, the sloped path 250 and the second straight path 280.

Here, a split path 242 of the first bypass path 240 has an angle opposed to a flow of fluid in the first straight path 220 and a split path 262 of the second bypass path 260 has an angle opposed to a flow of fluid in the sloped path 250.

Accordingly, in the case of fluid flowing in a forward direction, the fluid mostly flows according to the shortest course through the first straight path 220, the sloped path 250, and the second straight path 280.

Also, the fluid which fails to flow toward the outlet 142 is transferred in a reversed direction according to the second straight path 280, the second bypass path 260, the sloped path 250, the first bypass path 240, and the first straight path 220.

Here, the second straight path 280 and the second bypass path 260 are connected to each other in a straight line, and the sloped path 250 and the first bypass path 240 are connected to each other in a straight line.

Accordingly, the fluid which fails to flow toward the outlet 142 mostly flows in a reversed direction according to the second straight path 280, the second bypass path 260, the sloped path 250, the first bypass path 240, and the first straight path 220.

In the present embodiment, a single-unit bypass valve structure is formed in the laminate substrate 100. However, the first and second straight paths 220 and 280 may be consecutively connected by the sloped path 250, and they may be connected with the bypass paths 240 and 260, respectively.

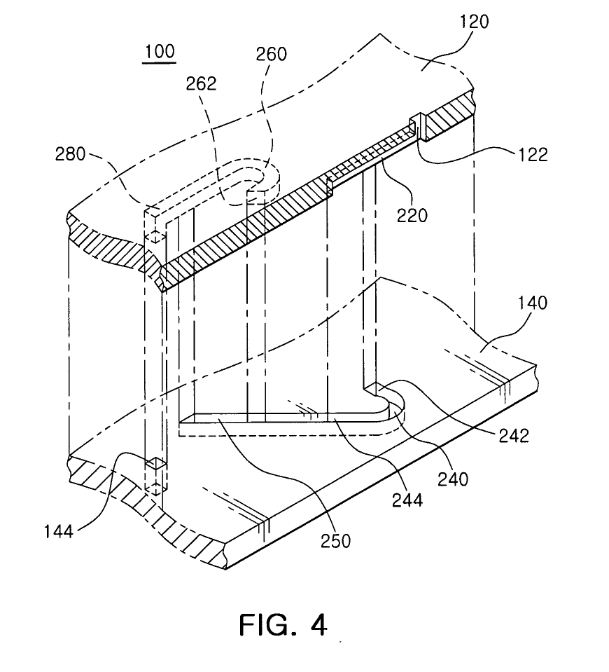

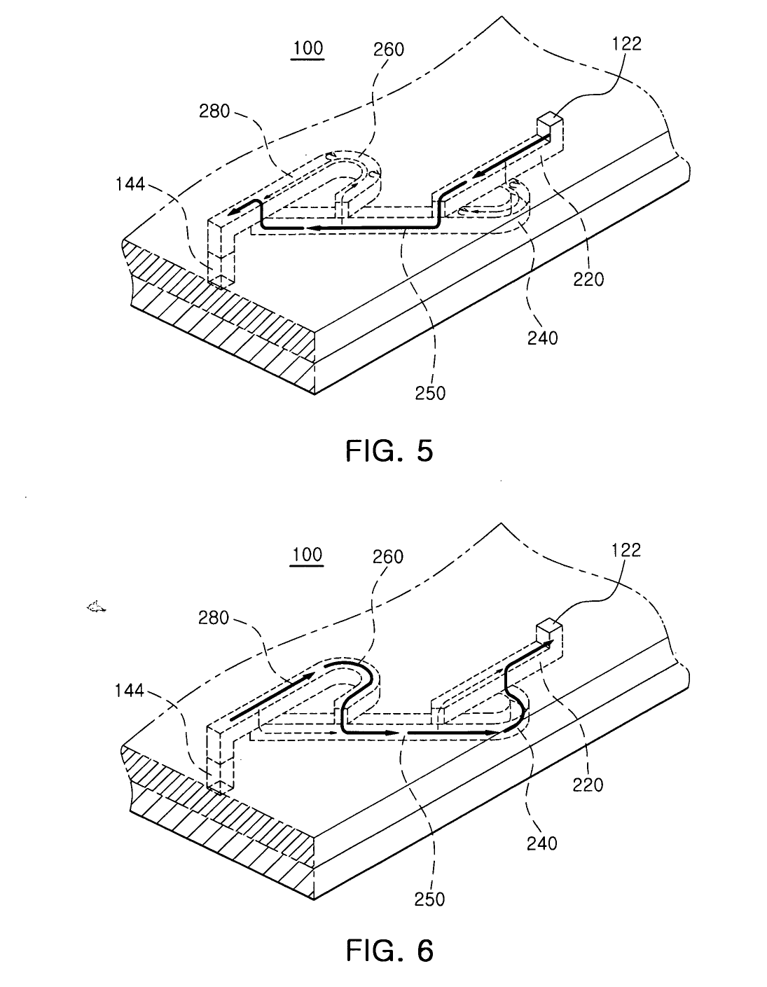

FIG. 4 is an exploded perspective view schematically illustrating a laminate substrate having a bypass valve structure according to another exemplary embodiment of the present invention. FIG. 5 schematically illustrates a flow of fluid in a forward direction in the bypass valve structure of FIG. 4. FIG. 6 schematically illustrates a flow of fluid in a reversed direction in the bypass valve structure of FIG. 4.

Referring to FIGS. 4 through 6, in the laminate substrate 100 having the bypass valve structure according to this embodiment in contrast to the aforementioned embodiment, the first straight path 220 and the sloped path 250 may be formed in respectively different substrates 120 and 140.

Also, the first and second straight paths 220 and 280 may be formed in a first substrate 120, and the sloped path 250 and the bypass paths 240 and 260 connected with at least one of the first and second straight paths 220 and 280 may be formed in a second substrate 140.

Here, the first and second substrates 120 and 140 may be one of upper and lower substrates.

The courses of fluid transfer in this embodiment are basically identical to those in the aforementioned embodiment.

However, in the case of fluid flowing in a forward direction, when the fluid is transferred from the first straight path 220 to the sloped path 250 and from the sloped path 250 to the second straight path 280, the fluid is required to move between different substrates. Also, in the case of fluid flowing in a reversed direction, when the fluid is transferred from the second bypass path 260 to the sloped path 250 and from the first bypass path 240 to the first straight path 220, the fluid is required to move between different substrates.

Particularly, in the case of fluid flowing in a reversed direction, vortex occurring when the fluid moves between different substrates allows for an increase in flow resistance to the reverse flow.

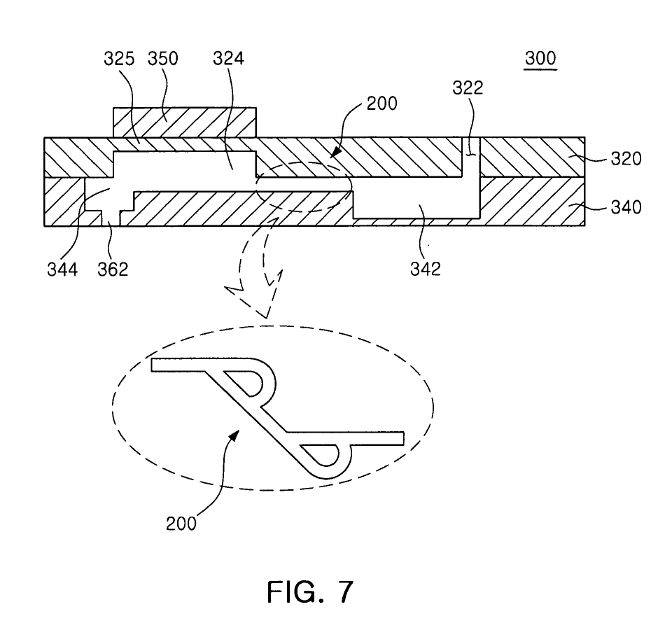

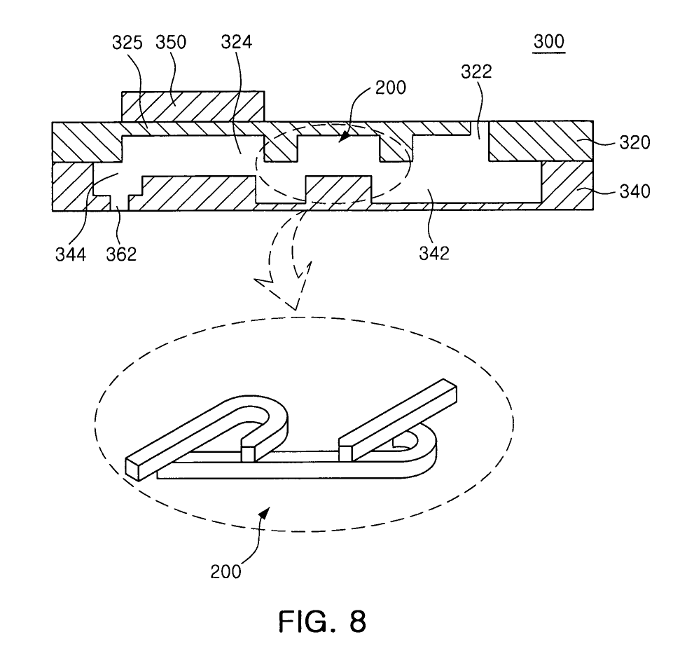

FIG. 7 schematically illustrates a restrictor having the bypass valve structure of FIG. 1 in an inkjet print head according to an exemplary embodiment of the present invention. FIG. 8 schematically illustrates a restrictor having the bypass valve structure of FIG. 4 in an inkjet print head according to another exemplary embodiment of the present invention.

An inkjet print head 300 according to an exemplary embodiment of the invention may include a reservoir 342, a pressure chamber 324, and a restrictor 200.

The inkjet print head 300 is formed by stacking a plurality of substrates. In the present embodiment, a two-layered structure of upper and lower substrates 320 and 340 is provided as an example.

If desired, a plurality of intermediate substrates may be stacked between the upper and lower substrates 320 and 340.

The upper substrate 320 may have an inlet 322 through which ink is drawn into the inkjet print head 300 and the pressure chamber 324 in which the ink is supplied with a driving force for ink ejection. On the top of the pressure chamber 324, a piezoelectric element 350 may be provided to have a membrane 325 disposed therebetween. The piezoelectric element 350 supplies the pressure chamber 324 with the driving force for ink ejection.

The piezoelectric element 350 may allow ink ejection to be made by transforming the membrane 325 that is the upper surface of the pressure chamber 324. A piezoelectric element may convert electrical energy into mechanical energy or vice versa, and its representative material is Pb(Zr,Ti)O₃. Also, for the ink ejection, a bubble jet or thermal jet method, besides a piezoelectric method using the piezoelectric element 350, may be used.

The lower substrate 340 may have a nozzle 362, a damper 344, the reservoir 342, and the restrictor 200 formed therein. The reservoir 342 stores ink inside the inkjet print head and the restrictor 200 prevents the ink of the pressure chamber 324 from flowing backward into the reservoir 342.

The piezoelectric element 350 may be formed to have electrodes on the top and bottom of a piezoelectric material layer that is transformed by current supply. Those upper and lower electrodes may be connected with a flexible printed circuit board in order to apply voltage thereto.

The nozzle 362 may eject the ink stored in the pressure chamber 324 in the form of droplets by the driving force of the piezoelectric element 350.

Here, the restrictor 200 of FIG. 7 is an example configured to have the bypass valve structure of FIGS. 1 through 3, and the restrictor 200 of FIG. 8 is an example configured to have the bypass valve structure of FIGS. 4 through 6.

A detailed description of the bypass valve structure will be replaced by that of the bypass valve structure in the aforementioned embodiments.

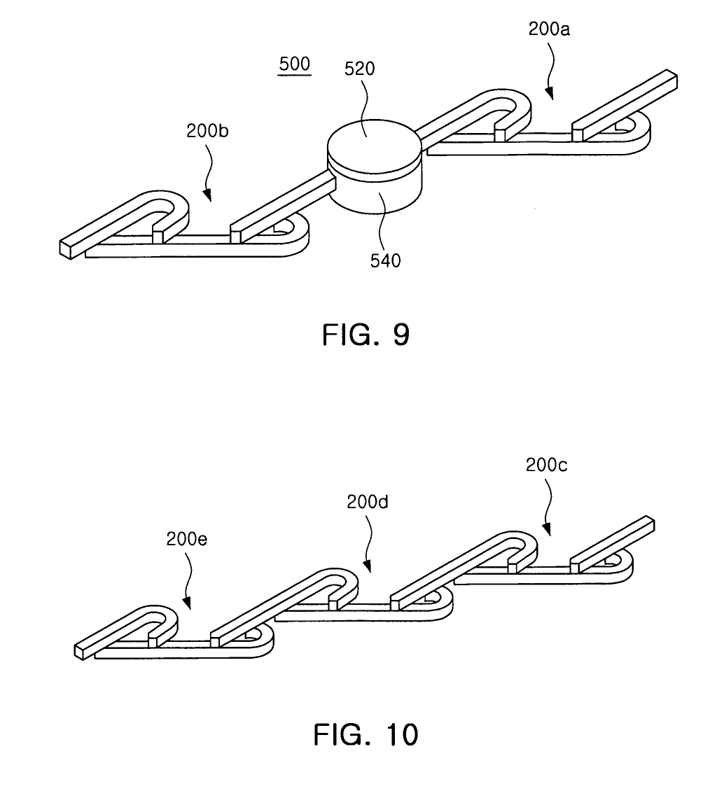

FIG. 9 schematically illustrates an inlet and an outlet having the bypass valve structure of FIG. 4 in a micro pump according to an exemplary embodiment of the present invention.

A micro pump 500 according to an exemplary embodiment of the invention may include a pressure chamber 540 having a piezoelectric element 520 allowing for the pumping of fluid, an inlet 200a through which the fluid is drawn into the pressure chamber 540 by the driving force of the piezoelectric element 520, and an outlet 200b through which the fluid is ejected from the pressure chamber 540.

In this embodiment, the pressure chamber 520, the inlet 200a, and the outlet 200b are formed in a laminate substrate. Although the three-dimensional bypass valve structure of FIG. 4 is depicted in FIG. 9, the two-dimensional bypass valve structure of FIG. 1 may be applied to this embodiment.

A detailed description of the bypass valve structure will be replaced by that of the bypass valve structure in the aforementioned embodiments.

FIG. 10 schematically illustrates a consecutive arrangement of bypass valve structures according to an exemplary embodiment of the present invention.

That is, bypass valve structures 200c, 200d and 200e may be consecutively arranged. These consecutively arranged bypass valve structures 200c, 200d and 200e may be used by being replaced as the restrictor 200 of the inkjet print head 300 or the inlet 200a and the outlet 200b of the micro pump 500.

In a laminate substrate having a bypass valve structure according to exemplary embodiments of the invention, a flow of fluid is smoothly directed in a forward direction, but it is interrupted in a reversed direction.

Also, by applying such a bypass valve structure to a restrictor of an inkjet print head, flow resistance to ink flowing backward into the restrictor after being ejected is generated to thereby improve ink ejection efficiency.

Moreover, the bypass valve structure may be easily applicable to an inkjet print head or a micro pump in which a flow of fluid in a laminate substrate may occur, so its application is varied.

As set forth above, a laminate substrate having a bypass valve structure according to exemplary embodiments of the invention allows for an uninterrupted flow of fluid in a forward direction and an interrupted flow of fluid in a reversed direction.

Also, when such a bypass valve structure is applied to a restrictor of an inkjet print head, flow resistance to ink flowing backward into the restrictor after being ejected is generated, whereby ink ejection efficiency is improved.

Furthermore, the bypass valve structure may be easily applicable to an inkjet print head or a micro pump in which a flow of fluid in a laminate substrate may occur, and thus the application thereof is varied.

While the present invention has been shown and described in connection with the exemplary embodiments, it will be apparent to those skilled in the art that modifications and variations can be made without departing from the spirit and scope of the invention as defined by the appended claims.

What is claimed is:

1. A laminate substrate comprising a bypass valve structure formed in the laminate substrate and including:
a sloped path connecting a first straight path with a second straight path; and
a bypass path connected with at least one of the first and second straight paths and configured as a curved path.

2. The laminate substrate of claim 1, wherein the first and second straight paths are consecutively connected by the sloped path, and at least one of the first and second straight paths is connected with the bypass path.

3. The laminate substrate of claim 1, wherein the first straight path and the sloped path are formed in different substrates.

4. The laminate substrate of claim 1, wherein the first and second straight paths are formed in a first substrate, and the sloped path and the bypass path connected with at least one of the first and second straight paths are formed in a second substrate.

5. An inkjet print head comprising:
a reservoir storing ink drawn through an inlet;
a pressure chamber storing the ink supplied by the reservoir before being ejected through a nozzle and allowing the stored ink to be ejected by a driving force of a piezoelectric element; and
a restrictor connecting the reservoir with the pressure chamber,
wherein the restrictor comprises:
a sloped path connecting a first straight path with a second straight path; and
a bypass path connected with at least one of the first and second straight paths and configured as a curved path.

6. The inkjet print head of claim 5, wherein the first and second straight paths are consecutively connected by the sloped path, and at least one of the first and second straight paths is connected with the bypass path.

7. The inkjet print head of claim 5, wherein the first straight path and the sloped path are formed in different substrates.

8. The inkjet print head of claim 5, wherein the first and second straight paths are formed in a first substrate, and the sloped path and the bypass path connected with at least one of the first and second straight paths are formed in a second substrate.

9. A micro pump comprising:
a pressure chamber including a piezoelectric element allowing for a pumping of fluid; and
an inlet and an outlet through which the fluid is respectively drawn into and ejected from the pressure chamber,
wherein at least one of the inlet and the outlet comprises a flow path structure formed in a laminate substrate and including a sloped path connecting a first straight path with a second straight path and a bypass path connected with at least one of the first and second straight paths and configured as a curved path.

10. The micro pump of claim 9, wherein the first and second straight paths are consecutively connected by the sloped path, and at least one of the first and second straight paths is connected with the bypass path.

11. The inkjet print head of claim 9, wherein the first straight path and the sloped path are formed in different substrates.

12. The inkjet print head of claim 9, wherein the first and second straight paths are formed in a first substrate, and the sloped path and the bypass path connected with at least one of the first and second straight paths are formed in a second substrate.
